(19) United States
(12) Patent Application Publication
(10) Pub. No.: US 2026/0307036 A1
(43) Pub. Date: Oct. 8, 2026

(54) Capsule drying method

(71) Applicant: KAPSERA, BORDEAUX (FR)

(72) Inventors: Antoine DREVELLE, ROMILLY SUR SEINE (FR); Wafa BOUHLEL, ANTIBES (FR); Edouard DULIEGE, MONTFORT SUR MEU (FR)

(21) Appl. No.: 18/879,023

(22) PCT Filed: Jun. 29, 2023
(86) PCT No.: PCT/EP2023/067859

§ 371 Date: Sep. 20, 2025

(30) Foreign Application Priority Data
Jun. 30, 2022 (FR) FR2206614

(51) Int. Cl. B01J 13/20; B01J 13/22

(52) U.S. Cl. CPC B01J 13/206; B01J 13/22

(57) ABSTRACT

A microcapsule with a core including a lipophilic phase surrounded by a gelled shell, and wherein the core further includes at least one active organic compound, the uses of the microcapsule in various fields of application such as crop and/or seed treatment, human and/or animal nutrition, cosmetics and pharmaceuticals, soil and wastewater decontamination, care products, and a method for treating crops and/or seeds.

This invention relates to a method for drying capsules having a shell formed from a gelled envelope mainly composed of biopolymer and a method for rehydrating these capsules. The present invention further relates to dehydrated capsules obtained by this drying method, and rehydrated capsules obtained following the rehydration method.

Capsule formulations are increasingly used in a wide range of technical fields, as they offer a number of advantages. Drying these capsules could make them easier to store and transport, in particular by reducing their volume and weight, but also by improving the stability of the product during storage.

Here, the invention relates to a method for drying a capsule
wherein the capsule comprises a shell and a core,
wherein the core of the capsule is aqueous, or of the oil-in-water emulsion type, or of the water-in-oil emulsion type,
wherein the shell is a gelled envelope mainly composed of at least one biopolymer;
wherein the shell has a thickness of at least 10 μm;
wherein said drying method comprises a step of fluidised bed drying and/or freeze-drying.

The invention further relates to a dehydrated capsule obtainable by the drying method according to the invention.

Secondly, the capsules can be rehydrated, preferably before use, particularly if they are more effective in hydrated form.

The invention further relates to a method for rehydrating dehydrated capsules, comprising suspending the dehydrated capsules in an aqueous medium.

Finally, the invention relates to the rehydrated capsule obtainable by the rehydration method of the invention.

### DETAILED DESCRIPTION OF THE INVENTION

### Capsule

“Capsule” in this context means a capsule comprising at least a core and a shell. Such capsules preferably comprise a liquid core encapsulated by a substantially solid gelled envelope. This type of capsule has applications in many technical fields. The shell comprises one or more concentric or non-concentric compartments. Preferably, the capsules according to the invention comprise a single core coated by the shell. Preferably, the capsules according to the invention have an average diameter of less than 10 mm in hydrated form.

These capsules are therefore very different from beads, as beads are mainly made up of a solid or gelled matrix comprising multiple small inclusions.

The use of capsules rather than beads also makes it possible to confine a larger-volume core.

According to a preferred embodiment of the invention, the capsules have a core volume to total capsule volume ratio of greater than 20%. These capsules make it possible to protect a large core volume, and therefore potentially a large active agent volume, for a given volume of shell.

Preferably, before drying, the capsules have a core/shell volume ratio of between 0.2 and 3, and more preferably between 0.5 and 2.

Capsules are well known to the skilled person and can be formed by different techniques and have different shell compositions.

Typically, the capsules used in the context of the invention are produced according to the manufacturing method described in French patent no. 2939012.

As described below, the capsules according to the invention may be dehydrated. However, when they are in hydrated form, such as in suspension in an aqueous solution, the capsules according to the invention have an average diameter of between 50 and 4000 μm, preferably between 100 and 2000 μm, more particularly between 200 and 1000 μm, advantageously between 200 and 600 μm. This average diameter can be measured by various techniques well known to those skilled in the art, such as granulometry based on the diffraction of laser light, fractionation by sieving, or imaging by optical microscopy.

In one embodiment, the capsules according to the invention also comprise an intermediate layer between the core and the shell. Preferably this layer is composed of at least one biopolymer in solution or hydrogel form.

### The Core

The core of the capsules according to the invention may be aqueous or in the form of an oil-in-water (O/W) emulsion or water-in-oil (W/O) emulsion. In one embodiment of the invention, the core is an oil-in-water microemulsion.

The core of the capsules according to the invention is preferably a liquid core. Preferably, the viscosity of the core is less than 2000 mPa·s.

“Aqueous core” means a core based on a predominantly aqueous phase.

In the case where the capsule core is in the form of an oil-in-water (O/W) emulsion or a water-in-oil (W/O) emulsion, oil or an oil mixture may be used, preferably oils of vegetable, mineral or synthetic origin or a mixture thereof. “Oil” means a fatty substance that is liquid at room temperature (25° C.) and atmospheric pressure.

### The Shell

The capsules according to the invention preferably comprise at least one core encapsulated by a substantially solid gelled envelope called the shell.

Preferably, the shell of the capsules according to the invention is mainly composed of a biopolymer with gelling properties; this biopolymer that forms a majority of the shell is hereinafter referred to as the main biopolymer. Examples of such biopolymers with gelling properties are alginate, gellan gum, xanthan gum, pectin, chitosan, agar, and carrageenan.

The materials that make up the shell are preferably biodegradable and biosourced. The shell is preferably semi-permeable to gases and low-molecular-weight molecules.

The gels forming the shell can be physical or chemical, i.e. formed by coacervation or polymerisation.

The gelling of these biopolymers can be achieved by a variation in temperature (gellan gum), a variation in pH (chitosan, pectin) or by ions (alginate, carrageenan).

Preferably, the shell of the capsules according to the invention is mainly composed of a biopolymer having gelling properties caused by ionic or temperature variation.

Preferably, the shell of the capsules according to the invention is mainly composed of alginate.

The shell may also comprise one or more biopolymers other than the main biopolymer, such as starch (in its various forms, e.g. amylose, pregelatinised starch), potato protein, or a biopolymer other than the main biopolymer having gelling properties, e.g. alginate, gellan gum, xanthan gum, pectin, chitosan, agar, or carrageenan.

Preferably, the shell of the capsules according to the invention comprises a gel containing water, one or more biopolymers with gelling properties, and optionally a surfactant resulting from its manufacturing method.

Preferably, the shell of the capsules according to the invention comprises a gel containing water, alkali alginate, and optionally a surfactant resulting from its manufacturing method.

Preferably the alkali alginate is a sodium alginate or a potassium alginate. Alginates are produced from brown algae that are also called seaweed. Such alginates advantageously have an α-L-guluronate content of over 50%, preferably over 55% or even over 60%.

The surfactant is advantageously an anionic surfactant, a non-ionic surfactant, a cationic surfactant or a mixture thereof. The molecular weight of the surfactant is between 150 g/mol and 10,000 g/mol, advantageously between 250 g/mol and 1,500 g/mol.

If the surfactant is an anionic surfactant, it is chosen, for example, from an alkyl sulphate, an alkyl sulphonate, an alkyl aryl sulphonate, an alkaline alkyl phosphate, a dialkyl sulphosuccinate, and an alkaline earth salt of saturated or unsaturated fatty acids. These surfactants advantageously have at least one hydrophobic hydrocarbon chain with a carbon number greater than 5, or even 10, and at least one hydrophilic anionic group, such as a sulphate, sulphonate, or carboxylate linked to one end of the hydrophobic chain. If the surfactant is a cationic surfactant, it is for example chosen from an alkylpyridium or alkylammonium halide salt such as n-ethyldodecylammonium chloride or bromide, cetylammonium chloride or bromide (CTAB). These surfactants advantageously have at least one hydrophobic hydrocarbon chain with a carbon number greater than 5, or even 10, and at least one hydrophilic cationic group, such as a quaternary ammonium cation. If the surfactant is a non-ionic surfactant, it is chosen, for example, from polyoxyethylenated and/or polyoxypropylenated derivatives of fatty alcohols, fatty acids, or alkylphenols, arylphenols, or from alkyl glucosides, polysorbates and cocamides.

In one embodiment, the surfactant is sodium lauryl sulphate (SLS) also known as sodium dodecyl sulphate and/or polyoxyethylene sorbitan monoleate (Polysorbate 80).

Preferably, the surfactant is polyoxyethylene sorbitan monoleate (Polysorbate 80).

In one embodiment, the mass content of surfactant in the shell is greater than 0.001% and advantageously greater than 0.1%. Advantageously, the concentration by mass of surfactant is approximately 0.03%.

The shell may further comprise other compounds, particularly to improve its resistance to drying. These compounds include biochar, for example. Preferably the biochar is present in a proportion of 0.1 to 20% by volume fraction in the shell, advantageously 0.5 to 15% by volume fraction in the shell, preferably 1 to 10% by volume fraction in the shell.

In the case of a capsule with an oily core, the shell may comprise a sedimentation agent, i.e. an inert agent, preferably mineral, to make the capsule heavier. In the case of capsules with an oily core, these tend to rise to the surface when they are contained in an aqueous liquid, so adding a sedimentation agent to the shell makes them heavier, preferably so that the capsules are suspended in the liquid containing them. For example, a sedimentation agent according to the invention can be chosen from talc and/or silica. In this case, the sedimentation agent is present in a volume fraction of 1 to 30% in the shell, advantageously in a volume fraction of 5 to 20% in the shell. However, depending on the density of the capsules and the liquid containing them, the person skilled in the art is able to estimate the quantity of sedimentation agent required to obtain the desired effect.

The capsule shell is at least 10 μm thick. This is because the inventors have shown that such a thick shell gives the capsule greater resistance to drying. If the shell membrane were thin, the capsule would be weakened and would not be able to withstand the mechanical shear/stress forces applied when the capsules are handled by the operator, for example, or the conditions under which the capsules are agitated during physical/chemical treatments, and would be at high risk of breaking.

However, a membrane that is too thick would lose its appeal.

In particular, the capsule shell has a thickness of between 10 μm and 1200 mm, advantageously between 20 μm and 800 μm, and more particularly between 20 μm and 400 μm.

In particular, relative to the diameter of the capsule, the shell of the microcapsule preferably has a thickness of between 0.1% and 30%, advantageously between 1% and 20%, and more particularly between 10% and 20% of the diameter of the capsule.

### Drying Method

The invention relates to a method for drying a capsule
wherein the capsule comprises a shell and a core,
wherein the core of the capsule is aqueous, or of the oil-in-water emulsion type, or of the water-in-oil emulsion type,
wherein the shell is a gelled envelope mainly composed of at least one biopolymer;
wherein said drying method comprises a step of fluidised bed drying and/or freeze-drying.

“Fluidised bed drying” means a method wherein a rising gas is brought into contact with a bed of particles (in this case capsules), where the weight of the capsules is offset by the flow of the gas. The capsule bed then behaves like a fluid. This technique increases the gas-capsule surface area in order to facilitate drying. Fluidised bed drying according to the invention can be carried out on a simple fluidised bed, a vibrated fluidised bed or a fluidised bed with an internal heat exchanger.

Preferably, before being dried on a fluidised bed, the capsules according to the invention are coated with an anti-caking agent.

“Anti-caking agent” means an agent which limits or prevents the agglutination of capsules or the formation of capsule lumps. Anti-caking agents are well known to those skilled in the art and include in particular calcium carbonate, tricalcium phosphate, calcium silicate, magnesium silicate, calcium stearate, magnesium stearate, magnesium carbonate, magnesium oxide, silicon dioxide, sodium aluminosilicate, sodium ferrocyanide, potassium ferrocyanide, and mixtures thereof.

Preferably, the anti-caking agent is calcium carbonate.

“Coating” in this context means applying a layer of powder to the surface of the capsules.

“Freeze-drying” means dehydration by sublimation of water. Preferably, the capsules are immersed in a bath of co-formulant, then frozen at at least −80° C. and then freeze-dried.

“Co-formulant” means an additional compound, with no biological activity of its own, used to facilitate capsule handling or to limit capsule degradation.

For example, a co-formulant could be a cryoprotectant. Cryoprotectants that can be used in the context of the invention are glycerol, poly-L-lysine, lactose, trehalose, inulin, glutamate, sodium ascorbate, magnesium sulphate, sodium bicarbonate, sucrose, maltodextrin, milk powder, and mixtures thereof.

In a preferred embodiment, the capsules are immersed in a bath of co-formulant comprising sucrose and more preferably comprising a concentration of between 50 and 500 g/L of sucrose.

In a preferred embodiment, the capsules are immersed in a bath of co-formulant comprising maltodextrin and more preferably comprising a concentration of between 50 and 500 g/L of maltodextrin.

In a preferred embodiment, the capsules are immersed in a bath of co-formulant comprising milk powder and more preferably comprising a concentration of between 20 and 150 g/L of milk powder.

The step of freezing at −80° C. is carried out until the core of the capsules is in a solid state. Preferably the capsules are frozen at −80° C. for at least 6 hours, and more preferably for at least 12 hours.

The drying method according to the invention produces capsules in dehydrated form.

Preferably the drying method reduces the moisture content by weight of the capsules by at least 70%, at least 80% and more particularly at least 90%.

Preferably, the dehydration is partial, and the capsules obtained have a moisture content of less than 10%, measured by a moisture analyser after dehydration.

The invention further relates to a dehydrated capsule obtainable by any of the dehydration methods of the invention.

Preferably, the capsules obtained have a moisture content of less than 10% by weight, measured by a moisture analyser after dehydration.

In dehydrated form, the average diameter of the capsule tends to decrease. Preferably, the capsule according to the invention has an average diameter of between 10 μm and 4 mm in dehydrated form.

### Rehydration Method

The present invention relates to a method for rehydrating dehydrated capsules, preferably dehydrated capsules according to the invention, said method comprising suspending the dehydrated capsules in an aqueous medium.

Preferably the aqueous medium consists mainly of water, preferably purified water such as ultrapure water. The aqueous medium may be saline solution, i.e. purified water containing 0.9% (w/v) sodium chloride.

In particular, the aqueous medium may be water supplemented with surfactant, for example with tween.

In one embodiment of the invention, if the dehydrated capsule does not comprise a living being or microorganisms, the rehydration method comprises suspending the dehydrated capsules in ultrapure water.

In another embodiment of the invention, if the dehydrated capsule comprises bacteria and/or viruses, the rehydration method comprises suspending the dehydrated capsules in saline solution.

In another embodiment of the invention, if the dehydrated capsule comprises fungi or spores, the rehydration method comprises suspending the dehydrated capsules in a surfactant-supplemented aqueous medium, preferably in saline solution supplemented with Tween.

Preferably, the dehydrated capsules are suspended in the aqueous medium for at least 30 minutes, preferably from 30 minutes to 1 hour. Preferably, the dehydrated capsules are suspended at room temperature, i.e. between 1° and 25° C. Suspension is preferably promoted by stirring.

The invention further relates to a rehydrated capsule obtainable by the rehydration method of the invention.

In the description and in the following examples, unless otherwise indicated, percentages are percentages by weight and ranges of values are expressed as “between . . . and . . . ”, “from . . . to . . . ” or “greater than . . . ” include the specified limits.

Throughout the application, the wording “comprising one” or “including one” means “comprising at least one” or “including at least one” unless otherwise specified.

The following examples are given by way of illustration and are not intended to limit the scope of the invention.

### Example 1: Test of Freeze-Drying Capsules and Rehydrating them

Two alginate capsule prototypes are being tested wherein the biochar included in the core of the capsule is used as a probe in order to estimate and/or quantify the number of capsules degraded and/or the quantity of probe lost during freeze-drying and rehydration.

The first prototype (prototype 1) comprises biochar only in the core of the capsule. The second prototype comprises biochar in the core and shell. In this case, the biochar incorporated into the capsule shell acts to stiffen the shell.

Prototype alginate capsules are formed under the following production conditions:

The injector nozzle has a diameter of 200 μm. The total flow rate of core and shell fluid named Qtot is 450 mL/h, the flow ratio between core and shell fluid named Rq is 0.8 and confers a membrane thickness of at least 30 μm.

The capsules are produced by immersion in a calcium chloride bath. A sample of the calcium chloride bath is taken to measure the biochar present in the bath. This is the proportion of biochar that has not been encapsulated (the encapsulation yield is slightly less than 100%). The capsules are then collected and washed with water to remove any biochar deposited on their surface.

A sample of wet capsules is taken to measure the biochar contained in the capsule. To do this, the capsules are incubated in a PBS/EDTA solution to solubilise the alginate shell and thus release the contents. The addition of PBS maintains the solution's physiological conditions of ionic strength and pH.

The remaining capsules are then incubated in a co-formulant bath (SM-Sucrose, i.e. a bath containing 300 g/L sucrose) and frozen at −80° C.

The capsules are then freeze-dried. After freeze-drying, the capsules are washed by suspending them in an ultrapure water solution so that they can be released into the continuous phase and the biochar resulting from the breakage of the capsules during the freezing/lyophilisation stage can be measured. After the washing stage, a sample is taken to measure the biochar contained in the capsules.

The “hydrated capsules” and “dehydrated capsules” columns measure the OD (optical density) and estimate the quantity of biochar recovered after dissolution of the capsules. This dissolution is achieved by solubilising the alginate hydrogel that forms the shell of the capsules. A solution of PBS/EDTA (phosphate-buffered saline/ethylene diamine tetra-acetic acid) is used to release the contents of the capsules into the continuous phase. EDTA chelates the calcium ions present in the shell.

The columns named “calcium bath” and “wash buffer” comprise the quantity of probe lost in these baths or buffers.

TABLE 1
Quantification of biochar at each stage of processing of prototype 1
Prototype 1

| | | Washing | Washing | | |
|---|---|---|---|---|---|
| | Cal- | buffer for | buffer for | | |
| | cium | hydrated | dehydrated | Hydrated | Dehydrated |
| Fraction | bath | capsules | capsules | capsules | capsules |
| Average OD | 0.01 | 0.006 | 0.19 | 5.9 | 2.5 |
| % Biochar | 5.54 | 1.04 | 7.06 | 93.41 | 92.94 |
| Standard | 0 | 0.98 | 0 | 1.69 | 0 |
| deviation | | | | | |

Thus in proportions, the fraction [washing buffer for dehydrated capsules] represents 7% of the total quantity of biochar and the fraction [dehydrated capsules] represents 100−7.06=92.94%.

The loss of biochar during the freeze-drying method is therefore estimated at only 7% with prototype 1.

TABLE 2
Quantification of biochar at each stage of processing of prototype 2
Prototype 2

| | | Washing | Washing | | |
|---|---|---|---|---|---|
| | Cal- | buffer for | buffer for | | |
| | cium | hydrated | dehydrated | Hydrated | Dehydrated |
| Fraction | bath | capsules | capsules | capsules | capsules |
| Average OD | 0.05 | 0.02 | 0.09 | 60 | 190 |
| % Biochar | 2.82 | 0.32 | 0.474 | 96.85 | 99.52 |
| Standard | 0 | 0 | 0 | 0 | 0 |
| deviation | | | | | |

The loss of biochar during the freeze-drying method is therefore estimated at only 0.5% with prototype 2. The loss of biochar is therefore reduced in the presence of biochar in the capsule shell by a factor of 10, from 7% to 0.5%

### Example 2: Test of Freeze-Drying Capsules Comprising a Bacteriophage and Rehydrating Them

Two alginate capsule prototypes are being tested wherein bacteriophages are included in the core of the capsule and are used as a living probe in order to quantify the number of capsules degraded and/or the quantity of probe lost during freeze-drying and rehydration. The first prototype (prototype 1) does not comprise biochar. The second prototype (prototype 2) comprises biochar in the shell.

Prototype alginate capsules are formed under the following production conditions:

The total flow rate of core and shell fluid named Qtot is 500 mL/h, the flow ratio between core and shell fluid, named Rq, is 0.8.

The average diameter of the two prototype capsules was 462 μm, with a coefficient of variation of 17%, and 542 μm, with a coefficient of variation of 18%. The shell thickness of these prototypes is at least 30 μm.

The bacteriophages in strain M13K07 are lytic bacteriophages that act selectively and specifically against the bacterial pathogen Escherichia coli.

TABLE 3
Quantification of bacteriophages during
capsule formation and drying

| | Inoculum | Wet product | Dry product |
|---|---|---|---|
| | concentration | concentration | concentration |
| Prototype | (CFU/ml) | (CFU/g) | (CFU/g) |
| Prototype 1 | 1.09^{E}+09 | 3.11^{E}+08 | 1.42^{E}+08 |
| Prototype 2 | 1.991^{E}+09 | 5.17^{E}+08 | 3.62^{E}+08 |

TABLE 4
Evaluation of bacteriophage losses during capsule drying

| Prototype | Loss of wet capsules | Loss of dry capsules |
|---|---|---|
| Prototype 1 | 1.3% | 96% |
| Prototype 2 | <0.1% | 94% |

The calculations are as follows:

$$loss of bacteriophages from wet capsules = \frac{\begin{matrix}( inoculum concentration * inoculum volume ) - \\ concentration of wet capules * \\ mass of wet capsules )\end{matrix}}{( inoculum concentration * inoculum volume )}$$

$$loss of bacteriophages from freeze - dried capsules = \frac{\begin{matrix}( inoculum concentration * inoculum volume ) - \\ concentration of freezedried capules * \\ mass of freezedried capsules )\end{matrix}}{( inoculum concentration * inoculum volume )}$$

The “encapsulation yield using the calcium bath method” is calculated by measuring the quantity of bacteriophage remaining in the bath, i.e. not encapsulated, compared with the quantity of bacteriophage used to form the capsules.

TABLE 5
Bacteriophage encapsulation yields

| | Encapsulation | Drying yield | |
|---|---|---|---|
| | yield (calcium | (calcium bath | Method |
| prototype | bath method) | method) | yield |
| Prototype 1 | 98.5% | 4.45% | 4.4% |
| Prototype 2 | 99.85% | 6% | 6% |

The loss of survival of bacteriophages during freeze-drying is estimated at 5%.

### Example 3: Capsule Fluidised Bed Drying Test

An alginate capsule prototype containing a bacterial strain was tested for drying on a fluidised air bed. The prototype alginate capsule is formed under the following production conditions:

The injector nozzle has a diameter of 150 μm. The total flow rate of core and shell fluid named Qtot is 350 mL/h, the flow ratio between core and shell fluid, named Rq, is 1, giving the capsules a membrane thickness of at least 20 μm.

Once the capsules have been produced and washed with saline solution, they are mixed with calcium carbonate in a 1:1 mass ratio before being dried on a fluidised air bed for 30 minutes. The temperature inside the enclosure remains below 45° C.

Once dry, the capsules are washed by resuspending them in saline solution to remove the calcium carbonate. A sample of capsules is taken to determine the bacterial concentration contained in the capsules.

Bacterial concentrations in wet and dry products were 5.48×10⁸ CFU/g and 4.11×10⁵ CFU/g respectively. The inventors have observed that the bacterial concentration of the prototype after drying in the fluidised air bed remains relatively high.

1. A capsule drying method wherein the capsule comprises a core and a shell, wherein the core of the capsule is aqueous, or of the oil-in-water emulsion type, or of the water-in-oil emulsion type, wherein the shell is a gelled envelope mainly composed of at least one biopolymer, wherein the shell has a thickness of at least 10 μm, the method comprising fluidized bed drying and/or freeze-drying.

2. The capsule drying method according to claim 1, wherein the shell is mainly composed of alginate.

3. The drying method according to claim 1, wherein the capsule before drying has a core/shell volume ratio of between 0.5 and 2.

4. The drying method according to claim 1, wherein the capsules are immersed in a bath of co-formulant, then frozen at at least −80° C. and then freeze-dried.

5. The drying method according to claim 1, comprising, before said fluidized bed drying, coating the capsules with an anti-caking agent.

6. A dehydrated capsule obtainable by the method according to claim 1.

7. A method for rehydrating dehydrated capsules according to claim 6, comprising suspending the dehydrated capsules in an aqueous medium.

8. A rehydrated capsule obtainable by the capsule rehydration method according to claim 7.
